(19) United States
(12) Patent Application Publication
(10) Pub. No.: US 2018/0217362 A1
(43) Pub. Date: Aug. 2, 2018

(54) LENS STRUCTURE ASSOCIABLE WITH AN IMAGE ACQUISITION DEVICE, IN PARTICULAR FOR MICROSCOPIC OBSERVATION

(71) Applicant: FONDAZIONE ISTITUTO ITALIANO DI TECNOLOGIA, Genova (IT)

(72) Inventors: Andrea ANTONINI, Alfonsine (RA) (IT); Tommaso FELLIN, Manesseno (GE) (IT)

(21) Appl. No.: 15/746,739

(22) PCT Filed: Jul. 15, 2016
(86) PCT No.: PCT/IB2016/054225

§ 371 Date: Jan. 22, 2018

(30) Foreign Application Priority Data
Jul. 22, 2015 (IT) 102015000036747

(51) Int. Cl. G02B 15/10; G02B 1/04; G02B 13/00; G02B 7/14; G03B 17/56

(52) U.S. Cl. CPC G02B 15/10; G02B 1/041; G03B 17/565; G02B 7/14; G02B 13/0025

(57) ABSTRACT

A lens structure includes a dorsal portion having a curved and/or convex surface and a ventral portion having an adhesive bottom surface that can be connected to an image acquisition device. The dorsal portion is substantially semi rigid or rigid and is made from a non-adhesive polymeric resin. The ventral portion includes a transparent and substantially flat support layer having the bottom surface on one side and, on the opposite side, an intermediate surface connected to the dorsal portion.

### TECHNICAL FIELD

The present invention relates to a lens structure associable with an image acquisition device, in particular for microscopic observation.

### BACKGROUND ART

Lens structures associable with an image acquisition device, in particular for microscopic observation, are known in the art.

Such lens structures offer the advantage that they exploit, when in use, the normal functionalities implemented in the image acquisition device, so that a wide range of magnification can be obtained, even in microscopic applications.

Such a type of lens structure is described in patent publication US 2014/0362239 A1. This publication discloses a “soft” lens structure entirely made from elastomer-based material, which exploits the peculiar adhesiveness of such material to adhere—in a removable manner—to the transparent cover window of an image sensor belonging to an image acquisition device, such as a camera, a cell phone, a smartphone or a tablet. Such a lens structure allows the cover to be removed from or repositioned onto the image sensor.

However, the above-mentioned lens structure has a few drawbacks.

One drawback is that, because of the properties of the material, the thickness of the substrate must be at least a few tenths of a millimeter (preferably 0.5 mm), so as to reduce the risk that it might break while repositioning the device or during the production process.

Another drawback is that all the surfaces of the body of the lens structure are adhesive. This implies that such a structure is not really “portable” and cannot be integrated into the image acquisition device with which said structure is associated. In fact, in such a case the lens structure would tend to be removed due to friction with other bodies. In addition, this problems makes the lens structure easily subject to fouling because of its surface adhesiveness. Moreover, the dirt deposited on the lens structure has a great influence on the optical properties of a microlens, since the size of the corpuscles is not negligible compared to the size of the optics (as opposed to macro-optical bodies). In this respect, in order to mitigate the above-described problems, said lens structure must be carried in a protective case and must be ideally removed and cleaned after each use.

A further drawback is that the elastomer-based material specified in the description of said prior document imposes a low refractive index, resulting in non-optimal optical performance.

One additional drawback is that the material of the lens structure described in the above-mentioned prior document offers poor adhesiveness for firmly securing it to the image acquisition device.

### SUMMARY OF THE INVENTION

It is one object of the present invention to provide a lens structure which can overcome these and other drawbacks of the prior art.

According to the present invention, this and other objects are achieved through a structure made in accordance with the appended independent claim.

It is to be understood that the appended claims are an integral part of the technical teachings provided in the following detailed description of the invention. In particular, the appended dependent claims define some preferred embodiments of the present invention, which include some optional technical features.

Further features and advantages of the present invention will become apparent from the following detailed description, which is supplied by way of non-limiting example with particular reference to the annexed drawings, which will be summarized below.

By means of the present invention, it is therefore possible to “transform” an image acquisition device, such as a camera, a smartphone or a tablet, into a medium-resolution microscope. For example, the obtainable magnification may lie in the range of 4× to 80×.

According to the present invention, in particular, the lens structure is at the same time highly integrable into an image acquisition device, adaptable to different models of such devices, portable, and resistant to wear.

Furthermore, thanks to advantageous, but optional, features of the present invention, it is possible to use materials having a high refractive index (greater than or equal to 1.5). A reduction in the dimensions of the lens structure, in particular a reduction in the thickness of the lens structure, can thus be obtained, the magnification factor being equal, compared to what can be obtained according to the teachings of the prior art.

### BRIEF DESCRIPTION OF THE DRAWINGS

FIG. 1 is a perspective view of a lens structure made in accordance with an illustrative embodiment of the present invention.

FIGS. 2 and 3 are, respectively, a top view and a side elevation view of the lens structure shown in FIG. 1.

FIGS. 4 and 5 are, respectively, a partial perspective view and an elevation view of a smartphone that incorporates the lens structure shown in the preceding figures.

FIGS. 6 and 7 are, respectively, a partial perspective view and a partial elevation view of another smartphone that incorporates the lens structure shown in FIGS. 1-3.

FIG. 8 is an explanatory and schematic side elevation view of a process for obtaining a mould through which one can manufacture a portion of the lens structure shown in the preceding figures.

### DETAILED DESCRIPTION OF THE INVENTION

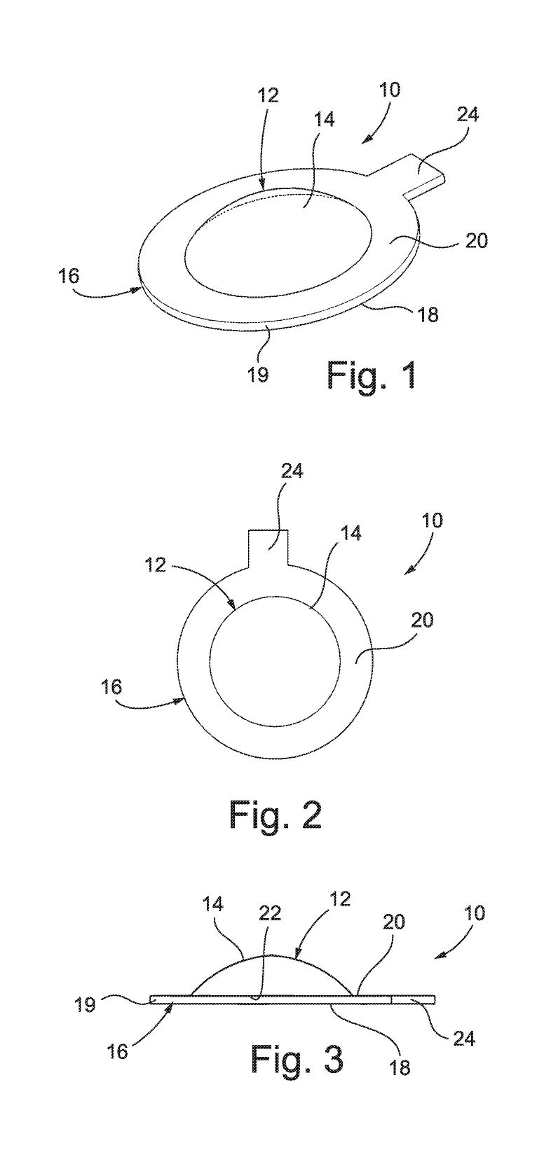

With particular reference to FIGS. 1 to 3, numeral 10 designates as a whole a lens structure designed in accordance with an illustrative embodiment of the present invention.

As will be further described below, the lens structure 10 is associable with an image acquisition device. By way of example, the image acquisition device may be of any type which can be used in an apparatus such as a camera, a cell phone, a smartphone, a tablet, an integrated optical display, augmented reality systems (e.g. glasses equipped with such technology), or the like.

As will be extensively described below, the image acquisition device with which the lens structure 10 can be associated generally includes, for example, an image sensor (e.g. CCD, CMOS or the like), an optical system consisting, in particular, of one or more lenses and a transparent protection cover (e.g. made of glass), located on top of the optical system and the sensor. When in use, the lens structure 10 can typically be applied over said protection cover or, if the latter is not present, over the outer surface of the last element of the optical system.

The optics of such image acquisition devices is generally designed for macroscopic photographic applications. In order to switch to microscopic observation, it is necessary to employ a lens structure having a greater numerical aperture as a terminal element of the optical system, before the sample to be analyzed. More in detail, optical systems for microscopic applications are characterized in that they can increase the resolution of the images in order to be able to distinguish microscopic details. The technical feature that determines the resolution of a microscope, in the absence of any aberrations, is the numerical aperture of the objective lens (given by n sin α, with α=arctan(D/2f), wherein f is the focal length of the lens and D is the diameter of the aperture of the objective lens). In order to improve the resolution, therefore, the ratio between diameter and focal length needs to be increased.

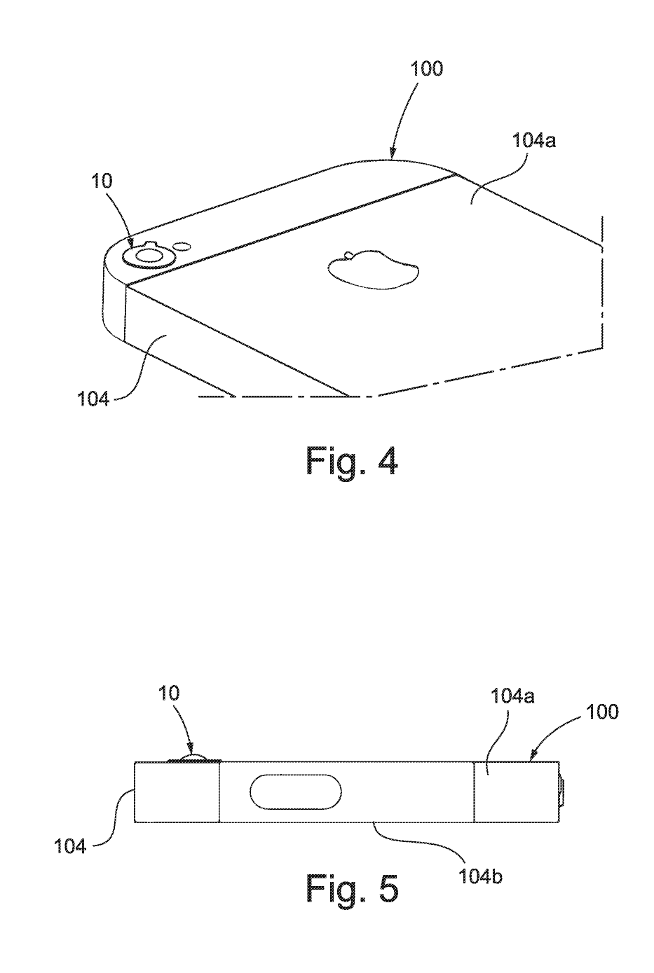

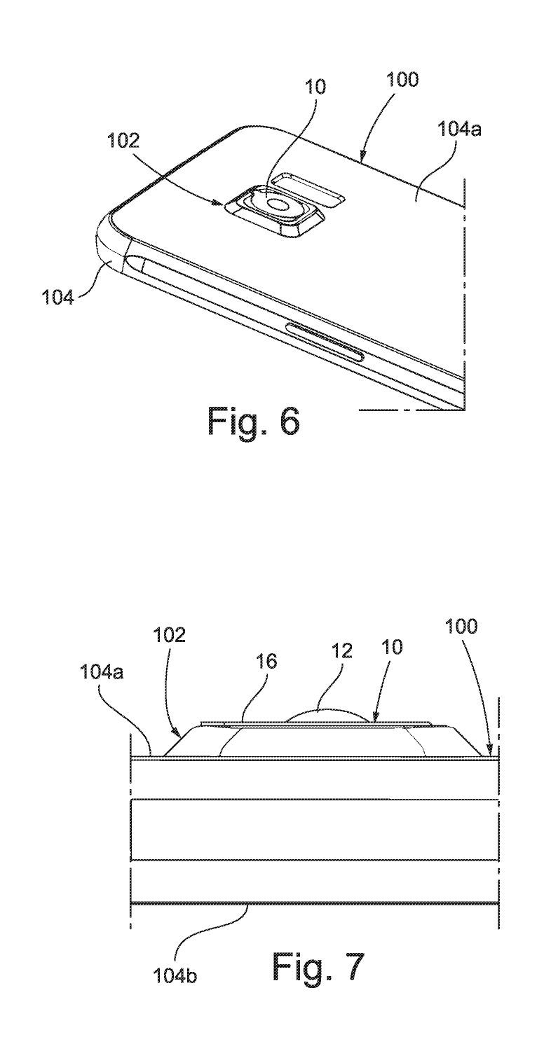

In FIGS. 4 to 7, the lens structure 10 is shown applied to two different types of apparatus including an image acquisition device. In particular, it can be noticed that such apparatus are—for example—smartphones 100 having their own image acquisition devices 102 (only numbered in FIGS. 6 and 7). More in detail, the image acquisition device 102 protrudes from the casing 104 of the smartphone 100. Typically, the electronic apparatus for which the present invention is intended include at least one image acquisition device 102. In the illustrated embodiment, the image acquisition device 102 protrudes from the back face 104a of the casing 104. In these figures, the lens structure 10 is applied to a transparent cover (generally made of glass and not numbered herein) of the image acquisition device 102, which protects the optical system incorporated into the smartphone 100. Of course, said smartphone may also have additional image acquisition devices located elsewhere (e.g. on the front face 104b thereof).

Referring back to FIGS. 1 to 3, the lens structure 10 comprises a dorsal portion 12 having a curved and/or convex top surface 14, and a ventral portion 16 having an adhesive bottom surface 18 that can be connected to the image acquisition device.

As will become apparent hereafter, the top surface 14 is—when in operation—intended to protrude outwards relative to the ventral portion 16. In other words, the top surface 14 protrudes on the side opposite to the ventral portion 16 relative to the image acquisition device with which the lens structure 10 is to be associated.

The dorsal portion 12 is substantially semirigid or rigid, and is made from a non-adhesive polymeric resin, while the ventral portion 16 comprises a transparent and substantially flat support layer (or film) 19. The support layer 19 has the bottom surface 18 on one side and, on the opposite side, an intermediate surface 20 connected to the dorsal portion 12. Due to such features, the lens structure 10 is easily portable and not very prone to soiling; in addition, the support 19 can be easily extended and shaped (e.g. cut) into shapes and lateral dimensions that are most suited to the design of the image acquisition device whereto it will be applied; as a consequence, the support layer can extend much past the convex region of the lens 12, or past the transparent cover of the image acquisition device 102. This will facilitate the application and removal of the support 19, thus making the lens structure 10 much more usable than the technical solutions commonly known in the art. The set 10 comprising—in particular consisting of—the convex part of the lens 14 and the support film can be removed from the device when the user wants to bring the image acquisition device back to its original functionality, without leaving any static coupling elements associated with the device. At the same time, as will be further described below, some additional preferred features will also allow obtaining a more compact lens structure, the curvature and diameter of the lens being equal.

In particular, the intermediate surface 20 is connected to a substantially flat base surface 22 borne by the dorsal portion 12 on the side opposite to the top surface 14.

In the illustrated embodiment, the lens structure 10 provides a planar-convex lens, in particular at the dorsal portion 12. More in detail, the top surface 14 defines the convex part of the lens, and the base surface 22 defines the planar part of said lens.

The diameter of the planar-convex lens is preferably smaller than the side of the window of the image acquisition device. By way of example, said diameter is less than 6 mm.

The resin used for making the dorsal portion 12 can be selected in a manner such that it can advantageously adhere directly to the intermediate surface 20 of the ventral portion 16. In other words, the dorsal portion of the lens 12 can be formed and polymerized directly on the surface 20 of the support 19, without requiring the assembling steps that would otherwise be necessary for attaching an already solid planar-convex element onto the support film 19. Because of this, it is also possible to extend the surface wetted by the resin that forms the dorsal portion 12 past the base surface 22. This lateral extension allows coating the support 19 to improve its scratch resistance or to change its mechanical characteristics and/or to increase its resistance to wear. As an alternative, it is also conceivable to select a resin that can adhere “indirectly” to the intermediate surface 20 via an additional coating or any thin intermediate means laid over said intermediate surface 20.

In particular, when the resin forming the dorsal portion 12 is polymerized, said resin will become rigid or semirigid (for example, with a Young modulus in the range of 100 MPa to 1700 Mpa) and will preferably create a smooth (and non-adhesive) surface on the top surface 14.

According to a preferred aspect of the present invention, the polymeric resin forming the dorsal portion 12 comprises at least one material selected from the group including:
an epoxy resin, in particular polymerizable by exposition to ultraviolet light or by means of thermal treatments,
a multi-component epoxy resin,
a urethane-based resin,
a styrene, polystyrene or unsaturated polyester-based resin,
an acrylic resin,
a silicone-based resin,
a polyurethane-based resin,
polycarbonate,
polymethylpentene or TPX,
polyallyl-diglycol-carbonate or CR39,
a terpolymer of acrylonitrile, butadiene or styrene;
a UV resin based on mercaptoesters (generally known as “UV mercaptoester-based adhesive”).

Preferably, the dorsal portion 12 is made from a polymeric resin having a refractive index greater than or equal to approx. 1.5. Thanks to this high refractive index property, it is possible to obtain a top surface 14 having less curvature than a lens structure providing the same magnification but having a smaller refractive index. This makes it possible to realize a lens structure 10 only slightly protruding outwards, which is therefore more compact and better integrated into the image acquisition device. This advantage becomes especially apparent in a comparison with US 2014/0362239 A1, wherein the elastomer-based material in use is polydimethylsiloxane (PDMS), which has a refractive index of less than 1.5. In addition to this, the possibility of obtaining a less sharp curvature of the top surface 14 will contribute to ensuring less optical aberrations (in particular, spherical and coma aberrations).

In particular, the dorsal portion 12 may have an aspheric shape.

Some examples of aspheric shapes are defined by the following formula:

$$Z = \frac{{cr}^{2}}{1 + \sqrt{1 - ( 1 + k ) {c}^{2} {r}^{2}}}$$

where:

z represents the height of the lens,

c is the curvature of the outer surface (inverse of the radius of curvature),

k is the conicity factor, and

r is the radius of the lens (not the radius of curvature, but the radius of the circle in the plane perpendicular to the optical axis).

Preferably, the parameters concerning the height of the lens (essentially corresponding to the height of the dorsal portion 12) are determined as follows:

⅛<|c|<½

2<|k|<3,

r<Rmax, with 0.5<Rmax<4.

The choice of said parameters within the above-specified ranges will ensure good optical performance over a larger planar field than can normally be obtained by using a lens having a spherical surface.

By way of example, below are listed some particularly advantageous values of the above-mentioned parameters that lie within the above-specified ranges, wherein the material of the dorsal portion 12 has a refractive index of 1.56:

c=−¼,

k=−2.4, and

r<Rmax, with Rmax=3

The support layer 19 may be a film made from polypropylene (PP), polyethylene (PE) polyethylenterephthalate (PET), polyvinyl chloride (PVC), plasticised polyvinyl chloride, ethylene vinyl acetate (EVA), polyolefins, polyamides, or any other plastic material generally employed for the protection of glass panels or screens of electronic devices.

In particular, the support layer is formed as a film, preferably a flexible one, so that it can be applied easily, and so that any air bubbles forming during the application can be removed by exerting a slight pressure. As clearly shown, in this second exemplary embodiment of the invention, the film covers the entire flat surface 22 of the convex region 12 and comes into direct contact with the transparent cover of the image acquisition device. By way of example, the direct contact between the soft material of the film and the transparent cover of the device will significantly reduce any light reflections and shape distortions compared to other solutions wherein there is an air gap between the lens and the transparent cover. Thinness and high flexibility allow said film to be applied onto an area which is larger than that of the transparent cover of the image acquisition device, without it being raised by any non-planarity present on the casing 104, which would be the case if a non-flexible or poorly flexible support layer were used, because of properties of its material or because of its thickness. Plasticized polyvinyl chloride, which is not a material commonly used for protecting smartphone screens because of its propensity to get scratched and its low rigidity, is however a material that is particularly well suited for use as a support film according to this invention; as previously described, scratch resistance and rigidity can be provided by the resin coating that forms the convex part 12 of the lens.

This film, the thickness of which is generally in the range of 25 microns and 500 microns, can be easily cut to shape as required by the user and in accordance with the characteristics of the electric device involved. For example, the area of this film may be greater than that of the transparent cover of the camera, thus providing a large area of contact with the casing 104 and increasing the adhesion force that unites the two elements, since the adhesion force is proportional to the contact area. Furthermore, said film may also be secured into the desired position by an external element, such as a protective cover (not shown) removable from the electronic device, so as to ensure stability of the component in the position desired by the user.

Preferably, the bottom surface 18 is made adhesive to allow it to be removably applied onto the image acquisition device. Therefore, a support layer 19 thus made will allow repositioning the lens structure 10 onto the image acquisition device in a simple and repeatable manner.

According to one embodiment of the present invention, the bottom surface 18 is made adhesive by applying a self-adhesive film that will allow removing the support layer 19—preferably in a repeatable manner—from the image acquisition device. For example, in this case the removable adhesive may be an acrylic or silicone-based adhesive.

According to a preferred embodiment of the present invention, the bottom surface 18 is made adhesive by charging the latter electrostatically (static cling). This configuration is preferred because, unlike the surface with a removable adhesive, wherein dirt may remain on the layer and cleaning is very difficult, electrostatic adhesion allows the surface to be easily cleaned. Any dirt will reduce the adhesion force and will be a cause for optical disturbance, since it will diffuse the light collected by the lens.

Thanks to the possibility of making the support film from a material other than that of the lens and with an area that may even be much greater than that of the lens, sufficient adhesion force can be attained even if the adhesion force per surface unit of the film is not particularly high. Moreover, in particular, this electrostatic adhesion may also be obtained by generating an electrostatic charge on the side opposite to that whereon the lens structure 10 is glued. In the case of a support layer 19 wherein the bottom surface 18 is charged electrostatically, the degree of adhesion can be determined while manufacturing the support layer 19, which is typically made as a film. This will give the option of adopting different characteristics in terms of mechanical adhesion and easiness of repositioning, without essentially leaving any residues on the bottom surface 18, which might deposit when the lens structure 10 is removed and then repositioned on the image acquisition device. This advantage cannot be attained according to the previously mentioned prior art described in US 2014/0362239 A1, since in that document the adhesive properties typical of the composition of the material of the lens structure are used, without any additional electrostatic charging steps.

Preferably, the ventral portion 16 comprises at least one grip region transversally protruding past the dorsal portion 12; in particular, said grip region may be borne by the support layer 19. In the illustrated embodiment, the grip region comprises a tab 24 transversally protruding from the periphery of the support layer 19. The user can thus grip the lens structure 10 more easily in order to remove it from the image acquisition device whereon it has been applied, without touching the lens.

In the illustrated embodiment, the ventral portion 16 extends transversally past the periphery of the dorsal portion 12. In particular, the support layer 19 defines, around the dorsal portion 12, an annular region that surrounds it externally. Said annular region may have a variable shape and size.

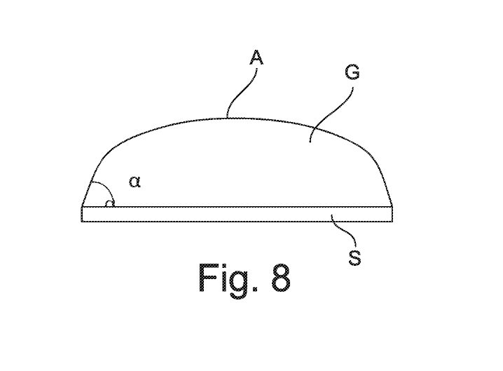

FIG. 8 illustrates some expedients for giving the desired shape to the dorsal portion 12 of the lens structure 10. By way of example, the following steps may be carried out for this purpose.

First of all, a flat substrate S having a diameter determined a priori, e.g. 1 to 8 mm, is prepared. The diameter of the substrate shall match the diameter of the base surface 22 exhibited by the dorsal portion 12, when viewed in a projection on the plane of the aperture of the optical system of the image acquisition device.

Subsequently, a drop of liquid resin G is deposited onto the substrate.

As aforementioned, the lens has an aspheric shape with particular mathematical characteristics, but a man skilled in the art will appreciate that other relevant geometrical shapes can also be obtained by depositing the drop of liquid resin G onto the circular substrate.

In particular, the drop of liquid resin G will generally tend to wet the entire surface of the circular substrate S, and—if the quantity of deposited resin is not excessive—will tend to remain constrained within the perimeter of said substrate. Depending on the surface tension between the drop of resin G and the air, and depending on the wettability of the surface of the circular substrate S by the drop of resin G, a curved surface A will be determined which will correspond to the shape of the top surface 14 of the dorsal portion 12. Said curved surface A will therefore have a perimetrically limited curvature capable of appropriately focusing the incident light. By changing the volume of the deposited drop of resin G, the diameter of the circular support S being equal, it will be possible to vary the curvature and conicity exhibited by the curved surface A. It will also be possible to obtain higher asphericity coefficients, in particular with a contact angle of 45°<β<100° between the substrate S and the drop of resin G.

The curved surface A thus obtained can be used for making a resin mould in which the same shape can be replicated, and through which it will be possible to obtain the dorsal portion 14 having a corresponding shape, by choosing the desired optical parameters and performance levels.

This manufacturing process allows obtaining lens structures 10 characterized by a very good surface finish and by dimensional shapes that ensure good optical performance, without requiring high-precision mechanical processing.

Of course, without prejudice to the principle of the invention, the forms of embodiment and the implementation details may be extensively varied from those described and illustrated herein by way of non-limiting example, without however departing from the scope of the invention as set out in the appended claims.

1. A lens structure associable with an image acquisition device for microscopic observation, comprising:
a dorsal portion having a curved and/or convex surface, and
a ventral portion having an adhesive bottom surface that can be connected to said image acquisition device;
wherein said dorsal portion is substantially semirigid or rigid and is made from a non-adhesive polymeric resin; and
said ventral portion comprises a transparent and substantially flat support layer having said bottom surface on one side and, on an opposite side, an intermediate surface connected to said dorsal portion.

2. The structure according to claim 1, wherein said polymeric resin comprises at least one material selected from the group including:
an epoxy resin, in particular polymerizable by exposition to ultraviolet light or by means of thermal treatments,
a multi-component epoxy resin,
a urethane-based resin,
a styrene, polystyrene or unsaturated polyester-based resin,
an acrylic resin,
a silicone-based resin,
a polyurethane-based resin,
polycarbonate,
polymethylpentene or TPX,
polyallyl-diglycol-carbonate (or CR39), and
a terpolymer of acrylonitrile, butadiene or styrene.
a UV resin based on mercaptoesters.

3. The structure according to claim 1, wherein said support layer is made from at least one material selected from the group including:
polypropylene,
polyethylene,
polyethylenterephthalate,
polyvinyl chloride,
plasticised polyvinyl chloride,
ethylene vinyl acetate,
polyolefins, and
polyamide.

4. The structure according to claim 1, wherein said bottom surface is removably applied to said image acquisition device.

5. The structure according to claim 4, wherein said bottom surface comprises a removable adhesive.

6. The structure according to claim 4, wherein said bottom surface is electrostatically adhesive.

7. The structure according to claim 1, wherein said support layer comprises at least one grip region transversally protruding past said dorsal portion.

8. The structure according to claim 1, wherein said polymeric resin has a refractive index greater than or equal to 1.5.

9. The structure according to claim 1, wherein said top surface has an aspherical shape.

10. The structure according to claim 9, wherein said aspherical shape is defined by the following formula
$$Z = \frac{{cr}^{2}}{1 + \sqrt{1 - ( 1 + k ) {c}^{2} {r}^{2}}}$$
where:
z represents a height of the lens,
c is a curvature of an outer surface and is a value in the range defined between ⅛<|c|<½,
k is a conicity factor, between 2<∥k|<3, and
r is a radius of the lens, where r<Rmax, with 0.5<Rmax<4.
